(19) United States
(12) Patent Application Publication
(10) Pub. No.: US 2017/0293905 A1
(43) Pub. Date: Oct. 12, 2017

(54) VOICE RECOGNIZED DATA ANALYSIS AND CORRECTIVE ACTION SYSTEMS AND METHODS

(71) Applicant: Restaurant Technology Inc., Oak Brook, IL (US)

(72) Inventors: Booker Washington, Romeoville, IL (US); Matthew Savard, Romeoville, IL (US); Kathy Dorsey, Oak Brook, IL (US); Trevor Kunkle, Romeoville, IL (US); Gilberto Pina, Oak Park, IL (US); Sigi Moeslinger, New York, NY (US); Sheri Byme-Haber, San Francisco, CA (US)

(21) Appl. No.: 15/482,686

(22) Filed: Apr. 7, 2017

Related U.S. Application Data
(60) Provisional application No. 62/320,208, filed on Apr. 8, 2016.

(51) Int. Cl. G06Q 20/20; G06F 3/0481; G10L 25/87; G06F 17/24; G10L 15/26; G06Q 50/12; G06F 3/0482

(52) U.S. Cl. CPC G06Q 20/20; G06Q 50/12; G06F 3/04817; G06F 3/0482; G06F 17/24; G10L 15/265; G10L 25/87

(57) ABSTRACT

Voice recognized data analysis and corrective action systems and methods are disclosed. An example disclosed method includes analyzing a transcript of an order to identify menu items within the transcript. The example method also includes removing words from the transcript that are not identifies as menu items. Additionally, the example method includes formatting, with a first format, the transcript to separate and highlight the identified menu items when the transcript is displayed on a screen.

### CROSS-REFERENCE TO RELATED APPLICATIONS

This application claims benefit of U.S. Provisional Patent Application No. 62/320,208, filed on Apr. 8, 2016, which is hereby incorporated by reference in its entirety.

### TECHNICAL FIELD

The present disclosure generally relates to point-of-sales systems and, more specifically, voice recognized data analysis and corrective action systems and methods.

### BACKGROUND

Restaurants serve a broad range of consumer expectations. The restaurant industry is continually striving to meet those expectations. Some restaurants, such as quick-service restaurants, target customers that have expectations about time and convenience. To meet those expectations, such restaurants often offer a drive-thru service which facilitates ordering from inside the consumer's vehicle. An additional facet of meeting consumer expectations is to offer a variety of menu items and options to tailor the menu items to a consumer particular tastes and needs. For example, restaurants permit consumers to customize a chosen menu item by selecting different food preparation styles, selecting different ingredients for inclusion or exclusion, selecting different beverage and side combinations, selecting different portion sizes, selecting different packaging, and so forth

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Exemplary embodiments provide systems and methods for voice recognized data analysis and corrective action. An example disclosed method includes analyzing a transcript of an order to identify menu items within the transcript. Additionally, the example method includes formatting, with a first format, the transcript to separate and highlight the identified menu items when the transcript is displayed on a screen.

An example apparatus includes an order decoder and an order formatter. The example order decoder is configured to analyze a transcript of an order to identify menu items within the transcript and remove words from the transcript that are not identifies as menu items. The example order formatter is configured to format, with a first format, the transcript to separate and highlight the identified menu items when the transcript is displayed on a screen.

An example tangible computer readable medium comprising instructions that, when executed, cause a machine to analyze a transcript of an order to identify menu items within the transcript. The instructions also cause the machine to remove words from the transcript that are not identifies as menu items. Additionally, instructions cause the machine to the format, with a first format, the transcript to separate and highlight the identified menu items when the transcript is displayed on a screen.

### BRIEF DESCRIPTION OF THE DRAWINGS

The invention can be better understood with reference to the following figures. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a system to perform voice recognized data analysis and corrective action in accordance with the teachings of this disclosure.

FIG. 2 illustrates the order parser of FIG. 1 to decode and format a transcribed order for display on a point-of-sale terminal.

FIG. 3 illustrates an operator evaluator to score the performance of a person operating the point-of-sale terminal.

FIG. 4 illustrates a processor platform to implement the order parser of FIGS. 1 and 2, and/or the operator evaluator of FIG. 3.

FIG. 5 is a flowchart of an example method to display a formatted speech on the point-of-sale terminal that may be implemented by the processor platform of FIG. 4.

FIG. 6 is a flowchart of an example method to parse and format the transcribed order that may be implemented by the processor platform of FIG. 4.

FIG. 7 is a flowchart of an example method to score an operator of the point-of-sale terminal that may be implemented by the processor platform of FIG. 4.

FIG. 8 is a flowchart of an example method to operate a speech-to-order system and/or a point-of-sale terminal in an operator input mode that may be implemented by the processor platform of FIG. 4.

FIG. 9 is a flowchart of an example method to operate a speech-to-order system and/or a point-of-sale terminal in an operator assist mode that may be implemented by the processor platform of FIG. 4.

FIG. 10 is a flowchart of an example method to operate a speech-to-order system and/or a point-of-sale terminal in an autonomous mode that may be implemented by the processor platform of FIG. 4.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Restaurants, such as quick-service restaurants, offer drive-thru ordering systems that facilitate customers ordering and receiving their order while in their vehicle. Menu boards that display available menu items include microphones, speakers, and displays to facilitate communication between the customer and an operator and/or an item ordering system. The customer speaks their order into the microphone and the operator, often wearing a headset, enters the order into a point-of-sale terminal. Often, the operator is multitasking and commits a portion of the order to memory before entering it into the point-of-sale terminal. The restaurant offers a variety of menu items and different ways to customize the menu items, such as changing a size, substituting items, and preparing the menu item without certain ingredients. As order complexity increases, errors may be introduced into the order when it is entered into the point-of-sale terminal. For example, the operator may forget to enter a “no onions” option when inputting an order including a hamburger. These errors cause customer dissatisfaction. The errors also decrease efficiency of the drive-thru system because of the extra time required to correct the errors.

As disclosed herein below, a speech-to-order system transforms the customer's speech into a microphone into a formatted transcript to be displayed on the point-of-sale terminal. The speech-to-order system groups and highlights menu items and associated variations (e.g. customizations, substitutions, sizes, etc.). In such a manner, the operator can verify the order before the order is submitted. Additionally, in some examples, the point-of-sale terminal verifies whether the operator input the order correctly. Additionally, in some examples, the speech-to-order system analyzes the speech the operator uses to interact with the customer. In some such examples, the speech-to-order system scores the word choice and order, tonality, and/or cadence of the operator's speech to determine whether the operator is providing good customer service. While the examples discussed below refer to restaurants, the system may be deployed in any suitable situation where a customer orders items via a microphone.

In some examples, the operator's interaction with the point-of-sale terminal is reduced. In some such examples, the speech-to-order system (a) transforms the customer's speech into a microphone into a formatted transcript to be displayed on the point-of-sale terminal and (b) enters the menu items (e.g., including the associated quantities and customization options) identified in the formatted transcript into the order input device. In such examples, the order is submitted into the item ordering system after the operator verifies (e.g. by submitting the order, etc.) that the menu items entered into the order input device match the menu items in the formatted transcript and/or the order as given by the customer. Alternatively, in some examples, the speech-to-order system (a) transforms the customer's speech into a microphone into a formatted transcript identifying menu items (e.g., including the associated quantities and customization options) and (b) enters the identified menu items (e.g., including the associated quantities and customization options) into the item ordering system without the input of the operator. In some such example, before entering the identified menu items into the item ordering system, the menu items are displayed on a display associated with the menu board. In such examples, the order is submitted to the item ordering system when the customer indicates (e.g. verbally, etc.) that the menu items on the display are correct.

In some examples, the speech-to-order system has multiple modes. In such examples, the speech-to-order system has (i) an operator input mode, (ii) an operator assist mode, and/or (iii) an autonomous mode. An administrator (e.g., a manager, etc.) may switch the speech-to-order system between the modes based on, for example, staffing levels, time of day, and/or customer traffic, etc. In the an operator input mode, (a) the speech-to-order system transforms the customer's speech into a microphone into a formatted transcript to be displayed on the point-of-sale terminal, and (b) the operator enters menu items into the order input device and submits the order into the item ordering system. In the operator assist mode, (a) the speech-to-order system transforms the customer's speech into a microphone into a formatted transcript to be displayed on the point-of-sale terminal and enters the menu items (e.g., including the associated quantities and customization options) identified in the formatted transcript into the order input device, and (b) the operator submits the order into the item ordering system. In the autonomous mode, the speech-to-order system transforms the customer's speech into a microphone into a formatted transcript and submits the order with the menu items identified in the formatted transcript into the item ordering system.

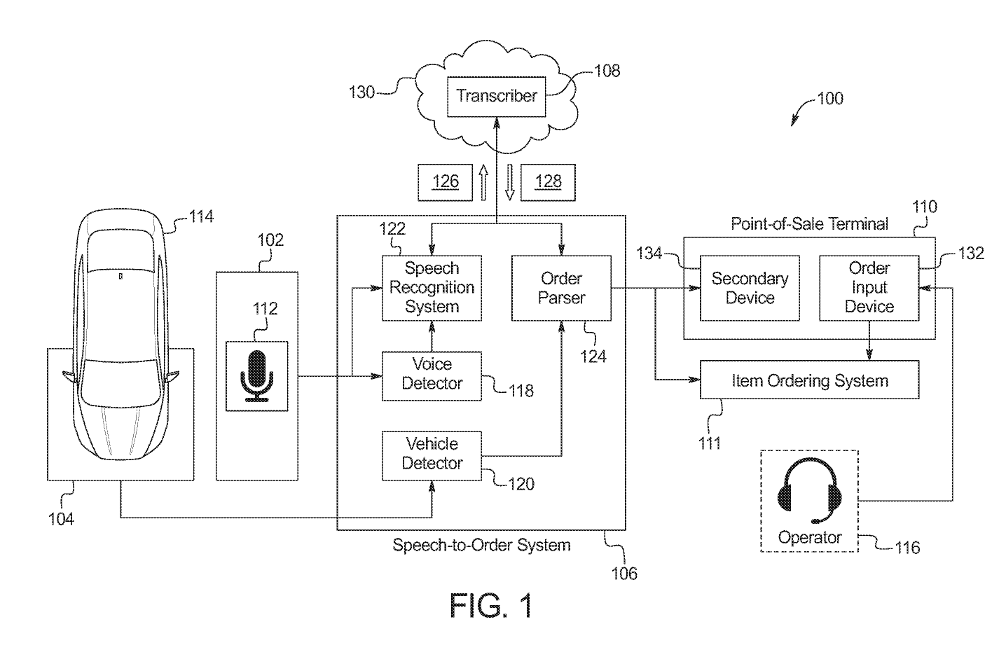

FIG. 1 illustrates a system 100 to perform voice recognized data analysis and corrective action in accordance with the teachings of this disclosure. In the illustrated example, the system 100 includes a menu board 102, a vehicle sensor 104, a speech-to-order system 106, a transcriber 108, a point-of-sale terminal 110, and an item ordering system 111. In some examples, the system may include multiple menu boards 102 and vehicle sensors 104, and multiple point-of-sale terminals 110. For example, the restaurant may have multiple drive-thru lanes to facilitate simultaneous orders from different customers.

The menu board 102 displays menu items to the consumer. The menu board 102 includes one or more displays (e.g. digital displays (liquid crystal displays (LCDs), organic light emitting diode (OLED) displays, etc.) and/or analog displays (e.g., back-lit display, etc.)) (not shown) and a sound system. In some examples, the menu board 102 also includes an order confirmation display (not shown). The sound system includes speaker(s) (not shown) and a microphone 112. The microphone 112 is positioned to capture speech by a customer in a vehicle 114. The sound system has multiple audio channels including one channel for an operator's voice and one channel for the microphone 112 to capture the customer's voice. In such a manner, the speech-to-order system 106 captures the speech of the customer (sometimes referred to as “customer audio”) over the first channel separately from the speech of an operator 116 (sometimes referred to as “operator audio”) over the second channel.

The vehicle sensor 104 detects when the vehicle 114 is proximate the menu board 102 signifying that the customer is present to place an order. In some examples, the vehicle sensor 104 includes an inductive loop embedded in the surface of a drive-thru lane proximate the menu board 102. In such examples, the presence of the metal of the vehicle 114 causes a signal oscillating on the inductive loop to change. In such examples, the vehicle sensor 104 detects the change and sends a signal to the speech-to-order system 106. Alternatively or additionally, the vehicle sensor 104 may use any other suitable method to detect the vehicle 114, such as by scale embedded in the drive-thru lane and/or a camera-based visual detection system.

The speech-to-order system 106 transforms the customer audio captured by the microphone 112 into a formatted transcript to be displayed on the point-of-sale terminal 110. In some examples, the speech-to-order system 106 is located on the premises of a restaurant. Alternatively, in some examples, the speech-to-order system 106 is hosted on an external network by a network hosting provider (e.g., a cloud services provider, etc.). In the illustrated example, the speech-to-order system 106 system includes a voice detector 118, a vehicle detector 120, a speech recognition system 122, and an order parser 124.

The voice detector 118 detects when the customer is speaking into the microphone 112. The voice detector 118 monitors the audio signal from the microphone 112 to detect when a customer is speaking so that the speech recognition system 122 processes audio when the customer is present and not when, for example, the microphone 112 captures ambient noise. Additionally, the voice detector 118 distinguishes between ambient noise (e.g., traffic noise, distant speech, natural noise, etc.) and the customer audio. In some examples, the voice detector 118 employs an ambient noise filter. When the voice detector 118 detects the customer audio, voice detector 118 sends a signal to the speech recognition system 122. In some examples, the voice detector 118 receives input from microphones 112 associated with different menu boards 102 in different lanes. In such examples, the signal generated by the voice detector 118 includes a lane identifier that identifies which lane with which the customer audio is associated.

The vehicle detector 120 monitors the vehicle sensor 104 to detect when the vehicle 114 is enters the vicinity of the menu board 102 and when the vehicle 114 leaves the vicinity of the menu board 102. When the vehicle detector 120 detects that the vehicle 114 is proximate to the menu board 102, the vehicle detector 120 sends a set signal to the order parser 124 signifying a new order. In some examples, when the vehicle detector 120 detects the vehicle 114 leaving the vicinity of the menu board 102, the vehicle detector 120 sends a reset signal to the order parser 124 signifying the end of the order. Alternatively, in some examples, when the vehicle detector 120 detects the next vehicle 114 proximate to the menu board 102, the vehicle detector 120 sends a momentary reset signal to the order parser 124. In some examples, the vehicle detector 120 monitors multiple ones of the vehicle sensors 104 associated with different lanes. In such examples, the set signal and the reset signal include the lane identifier that identifies which lane with which the set signal and the reset signal are associated.

The speech recognition system 122 records the customer audio captured by the microphone 112 and prepares the customer audio to be transcribed by the transcriber 108. To prepare the customer audio, the speech recognition system 122 applies one or more filters to reduce ambient noise, to reduce static noise, and/or to increase the volume of the customer's voice, etc. The speech recognition system 122 generates speech requests 126 based on the filtered customer audio. The speech requests 126 are size-limited portions (e.g., 1024 bytes, etc.) of the filtered customer audio in a format specified by the transcriber 108. For example, the speech requests 126 may be in an uncompressed format (e.g., Waveform Audio File Format (WAV), Audio Interchange File Format (AIFF), etc.) or a lossless compressed format (e.g., Windows Media Audio (WMA), Free Lossless Audio Codec (FLAC), etc.). Because the speech requests 126 are size-limited, the speech recognition system 122 sends multiple speech requests 126 to the transcriber 108 as the customer is speaking into the microphone 112. In some examples, the speech requests 126 include the lane identifier received from the voice detector 118. In such a manner, the speech recognition system 122 can process customer audio from multiple lanes asynchronously.

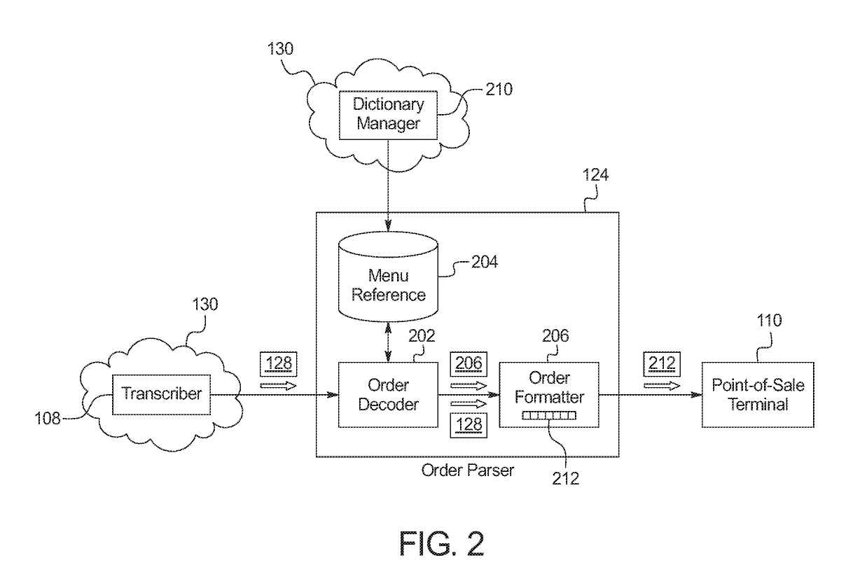

As discussed below in connection with FIG. 2, the order parser 124 formats speech responses 128 received from the transcriber 108 to be displayed on the point-of-sale terminal 110. The order parser 124 manages an order buffer (e.g., the order buffer 212 of FIG. 2 below) that the point-of-sale terminal 110 uses to display the order transcripts contained in the speech responses 128. In some examples, initially, the order parser 124 places the text of the speech response 128 into the order buffer. In such examples, after formatting the transcribed order in the speech response 128, the order parser 124 modifies the corresponding portion of the order buffer to include the formatting. In some examples, the order parser 124 saves the transcribed orders in a database to be scored for accuracy. In some such examples, the stored transcribed orders are used to improve the performance of the transcriber 108.

In the illustrated example, the order parser 124 receives a set signal from the vehicle detector 120 when the vehicle detector 120 detects the vehicle 114 entering the vehicle sensor 104. In response to the set signal, the order parser 124 inserts the order transcripts in the speech responses 128 into the order buffer. In such a manner, the point-of-sale terminal 110 displays the transcribed text from the transcriber 108 (e.g., the order transcript) when the vehicle 114 is present (i.e. the presence of the vehicle 114 implies the presence of a customer). In some examples, the order parser 124 receives a reset signal from the vehicle detector 120 when the vehicle detector 120 detects the vehicle 114 leaving the vehicle sensor 104. Alternatively, in some examples, the order parser 124 receives a reset signal from the vehicle detector 120 when the vehicle detector 120 detects the next vehicle 114. In response to the reset signal, the order parser 124 clears the order buffer in preparation for a new order. In some examples, the order parser 124 maintains multiple order buffers that correspond to different lanes. In such examples, the order parser 124 adds order transcripts in the speech responses 128 that include the lane identifier into the order buffer that corresponds to the lane identifier. In such a manner, a single point-of-sale terminal 110 may process orders from multiple lanes.

The transcriber 108 transcribes the customer audio in the speech requests 126 received from the speech recognition system 122 and returned the order transcript with the speech responses 128. In the illustrated example, the transcriber 108 is a service executing on an external network 130. In some examples, the external network 130 is a public network, such as the Internet; a private network, such as an intranet; or combinations thereof, and may utilize a variety of networking protocols now available or later developed including, but not limited to, TCP/IP-based networking protocols. The transcriber 108 may be hosted by a cloud service provider (e.g., Microsoft Azure®, Amazon Web Services™, Google Cloud Computing, etc.). The transcriber 108 provides an application programming interface (API) that facilitates the speech-to-order system 106 interacting (e.g., sending the speech requests 126, receiving the speech responses 128, etc.) with the transcriber 108.

The transcriber 108 includes one or more standard dictionaries and one or more custom dictionaries. In some examples, the standard dictionaries and the custom dictionaries may correspond to different languages. For example, a first standard dictionary and a first custom dictionary may contain English words and/or phrases. As another example, a second standard dictionary and a second custom dictionary may contain Spanish words and/or phrases. In some examples, the speech requests 126 may identify which set of dictionaries to use. For example, the language may be selectable (e.g., on the point-of-sale terminal 110) per order. The standard dictionary includes words and phrases (such as “I would like,” “ketchup,” etc.) that the transcriber 108 can understand that are not specific to the system 100. Additionally, the custom dictionary includes words and phrases (such as “happy meal,” “chipotle-ranch sauce,” etc.) that are specific to the menu of the restaurant in which the point-of-sale terminal 110 is located. The transcriber 108 is trained (e.g., via statistical analysis, language modeling, and/or neural networks, etc.) to recognize words and sentence patterns in the speech requests 126. In some examples, the transcriber 108 is trained specifically in the item ordering context so that ambiguity in the speech request 126 is resolved in a manner favoring the item ordering context. For example, ambiguity of the homonyms “meet” and “meat” are resolved in favor of the item ordering context (e.g., “meat”). Additionally, in some examples, the transcriber 108 includes data that specifies the popularity of menu items, broken down by time of day. In such a manner, based on the training, the dictionaries, and the popularity data, the transcriber 108 may infer portions of the speech requests 126 that are inaudible.

In some examples, the transcriber 108 may provide literal transcripts (e.g., a word for word transcription) in the speech responses 128. Alternatively, in some examples, the transcriber 108 may provide efficient transcripts in the speech responses 128. The efficient transcripts may omit words and/or phrases that the transcriber 108 determines are not relevant to the order. For example, the transcriber 108 may remove filler words (e.g., “um,” “so,” “look,” etc.) and transition words (e.g., “additionally,” “and,” “maybe,” etc.). For example, the transcriber 108 may transcribe the speech request 126 containing the customer audio of “I'd like to order one large chocolate milk shake and, um . . . be quiet Sam . . . maybe a small order of fries,” into “one large chocolate milk shake, a small order of fries.” Additionally, in some examples, the transcriber 108 applies inverse text normalization, capitalization, punctuation and/or profanity masking to the text. After transcribing the speech request 126 and apply filters to the resulting transcript, the transcriber 108 includes the transcript into a speech response 128. In some example, the transcriber 108 formats the transcript into a markup language (e.g., Extensible Markup Language (XML), JSON, etc.). The transcriber 108 then sends the speech response 128 to the speech-to-order system 106. In some examples, the speech response 128 includes the lane identifier included with the corresponding speech request 126.

The point-of-sale terminal 110 provides an interface between the operator 116 and the item ordering system 111. The point-of-sale terminal 110 includes digital and/or analog interfaces (e.g., input devices and output devices) to receive input from the operator 116 and display information to the operator 116. In the illustrated example, the point-of-sale terminal 110 includes an order input device 132 and a secondary display device 134. The order input device 132 facilitates the operator 116 entering the order to be provided to the item ordering system 111. In some examples, the order input device 132 is a touch screen display that displays (i) the order as entered so far, and (ii) icons representative of menu items, submenus, and/or item customization options. In such examples, the order input device 132 facilitates entering and/or modifying the order via the touch screen.

The secondary display device 134 is a display (e.g., a liquid crystal display (“LCD”), an organic light emitting diode (“OLED”) display, a flat panel display, a solid state display, optical head-mounted display, etc.) that displays the contents of the order buffer maintained by the order parser 124. In some examples, the secondary display device 134 is a touch screen display. In some examples, the secondary display device 134 may interact with the order input device 132 to modify the icons displayed on the order input device 132 based on menu items displayed on the secondary display device 134. For example, the menu items displayed on the secondary display device 134 may be highlighted on the order input device 132. In some examples, the order input device 132 and the secondary display device 134 may be the same display. Additionally, in some examples, in response to an input (e.g., activation of a “new employee button,” etc.) to the order input device 132, the secondary display device 134 displays a reference (e.g., a submenu identifier, an icon, an arrow, etc.) to facilitate locating, on the order input device 132, a menu item displayed on the secondary display device 134.

In some examples, the speech-to-order system 106 and/or the point-of-sale terminal 110 have multiple modes. In such examples, the speech-to-order system 106 has (i) an operator input mode, (ii) an operator assist mode, and/or (iii) an autonomous mode. In the an operator input mode, (a) the speech-to-order system 106 transforms the customer's speech into the microphone 112 into a formatted transcript to be displayed on the point-of-sale terminal 110, and (b) the point-of-sale terminal 110 (i) receives an input, from the operator 116, of menu items via the order input device 132 and (ii) submits the menu items as an order into the item ordering system 111 when directed by the operator 116 via the order input device 132. In the operator assist mode, (a) the speech-to-order system 106 (i) transforms the customer's speech into the microphone 112 into the formatted transcript to be displayed on the secondary display device 134 on the point-of-sale terminal 110 and (ii) enters the menu items (e.g., including the associated quantities and customization options) identified in the formatted transcript into the order input device 132 of the point-of-sale terminal 110 without direct interaction of the operator 116, and (b) submits the menu items as an order into the item ordering system 111 when directed by the operator 116 via the order input device 132. For example, the operator 116 may review the menu items entered into the order input device 132 and then press a “Submit” button when satisfied that the menu items are correct (e.g., correspond to the actual menu items that the customer ordered). In the autonomous mode, the speech-to-order system 106 transforms the customer's speech into the microphone 112 into the formatted transcript and submits the order containing the menu items identified in the formatted transcript into the item ordering system 111 without direct intervention by the operator 116.

The item ordering system 111 processes the menu items entered into the order input device 132 and routes the order to the appropriate location to be filled. The item ordering system 111 may also include inventory management based on the orders. In some examples, the item ordering system 111 receives the order buffer from the order parser 124. In such examples, when one or more menu items are identified in the order buffer, the item ordering system 111 may process the menu items independent of the order input device 132. Additionally, in some examples, the item ordering system 111 receives the order buffer from the order parser 124 and the order input from the order input device 132. In some such examples, the item ordering system 111 compares the menu items in the order buffer to the menu items from the order input. In some such examples, the item ordering system 111 alerts the operator 116, via the order input device 132 and/or the secondary display device 134, of any discrepancies between the menu items in the order buffer to the menu items from the order input. In such examples, the item ordering system 111 pauses fulfilling the order until the operator 116 confirms the order via the order input device 132.

FIG. 2 illustrates the order parser 124 of FIG. 1 to decode and format speech for display on a point-of-sale terminal 110. In the illustrated example, the order parser 124 includes an order decoder 202, a menu reference database 204, and an order formatter 206.

The order decoder 202 identifies menu items, quantities and/or customization options in the order transcripts received with the speech responses 128 from the transcriber 108 of FIG. 1. The order decoder 202 compares words and phrases in the order transcripts to words and phrases in the menu reference database 204. When a word or phrase in the order transcripts matches a word or phrase in the menu reference database 204, the corresponding entry in the dictionary database specifies a type (e.g. a menu item word/phrase, a quantity word/phrase, a customization word/phrase, etc.) of word or phrase. The order decoder 202 inserts one or more flags (e.g. symbols, predefined combinations alphanumeric characters, etc.) before and/or after the words and/or phrases that are found in the menu reference database 204. In some examples, the flags correspond to the type of the word or phrase identified by the menu reference database 204. For example, the order transcripts that contains the text of “one salad please with ranch dressing on the side” may be changed to “&q one &!q &mi salad &!mi please with &con ranch dressing &!con &mod on the side &!mod.”

In some examples, the order decoder 202 passes undecoded order transcripts (e.g., order transcripts that have not been compared against the menu reference database 204) to the order formatter 206 before checking the order transcript against the menu reference database 204. In some such examples, the order decoder 202 appends an identifier to the undecoded order transcript when it sends the undecoded order transcript to the order formatter 206. After checking the order transcript against the menu reference database 204 (e.g., decodes the order transcripts), the order decoder 202 sends decoded order transcript 208 to the order formatter 206. In some examples, the order decoder 202 appends, to the decoded order transcripts 208, the identifier appended to the corresponding undecoded order transcript to facilitate the order formatter 206 replacing the undecoded order transcript with the corresponding decoded order transcripts 208. In some examples, the order decoder 202 ignores the order transcripts unless the order decoder 202 receives the set signal from the vehicle detector 120 of FIG. 1.

In some examples, when generating the decoded order transcripts 208 from the undecoded order transcripts contained in the speech responses 128, the order decoder 202 discards words and/or phrases that do not appear in the menu reference database 204. For example, text the undecoded speech responses 128 that states “one salad please with ranch dressing on the side” may be truncated to “one salad ranch dressing on the side.” From time to time, a dictionary manager 210 updates the menu reference database 204. For example, the dictionary manager 210 may update the menu reference database 204 in response to changes to menu items.

In some examples, the order decoder 202 tracks and analyzes the types the word or phrase identified by the menu reference database 204 in the decoded order transcripts 208 contained in the speech responses 128 for an order. In such examples, the order decoder 202 assigns a complexity value (e.g., low complexity, medium complexity, high complexity, etc.) to the order. The complexity value is based on a number of menu items identified in the order, a number of customizations identified in the order, and/or the length of time to take the order, etc. For example, the order decoder 202 may determine that the order has a medium complexity if a menu item (e.g., a hamburger, coffee, etc.) has two or more customizations (e.g., “no pickles and no mustard,” “cream and three sugars,” etc.). As another example, the order decoder 202 may determine that the order has a high complexity if multiple menu items (e.g., a hamburger, coffee, etc.) has two or more customizations. The order decoder 202 send the complexity value to the order formatter 206 to be displayed on the secondary display device 134 (e.g., via the order buffer 212).

The order formatter 206 maintains the order buffer 212. The order buffer 212 is sized to fit a combination of the undecoded order transcripts and the decoded order transcripts 208 that represent an order. The order formatter 206 inserts the text form the undecoded order transcripts and/or the decoded order transcripts 208 into the order buffer 212. If the one of the undecoded order transcripts and/or one of the decoded order transcripts 208 received from the order decoded 202 is associated with a new identifier (e.g., an identifier not associated with an undecoded order transcript or an decoded order transcript 208 in the buffer), the order formatter 206 inserts the corresponding one of the undecoded order transcripts and/or one of the decoded order transcripts 208 at the end of the order buffer 212. If one of the decoded order transcripts 208 received from the order decoded 202 is associated with an identifier already associated with one of the undecoded order transcripts in the order buffer 212, the order formatter 206 replaces the text of the one of the undecoded order transcripts with the text of the one of the decoded order transcript 208. Additionally, the order formatter 206 removed the flags inserted by the order decoder 202 and, in some examples, replace the flags with control characters (e.g., a newline character, etc.) and/or a character that informs the speech display to reverse the text color and the background color of that character (sometimes referred to as “highlighting”) depending on the type of flag. For example, the order formatter 206 may insert a new line character after a menu item word/phrase or a customization word/phrase. From time to time, the order formatter 206 sends the order buffer 212 to the point-of-sale terminal 110 to be displayed on the secondary display device 134.

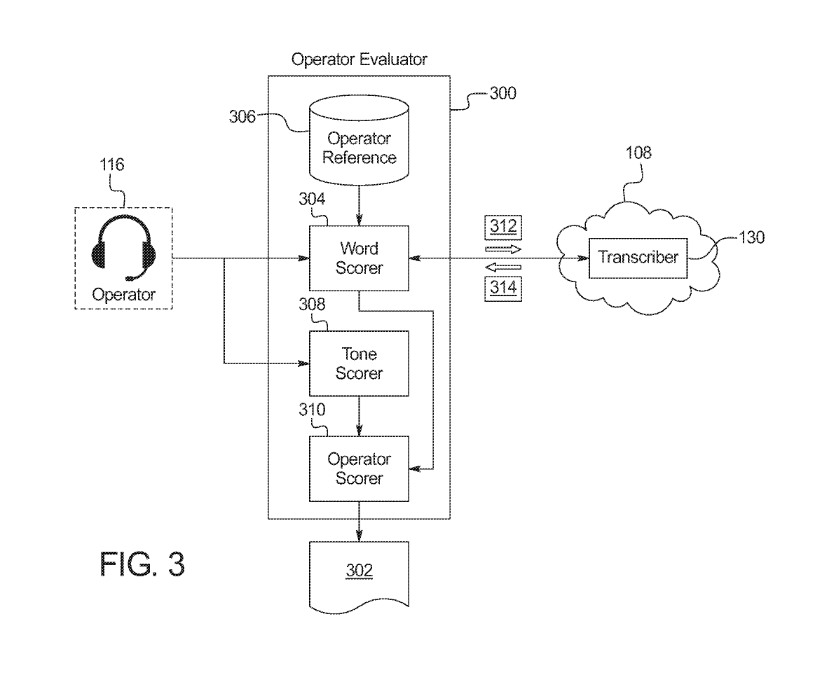

FIG. 3 illustrates an operator evaluator 300 to score the performance the operator 116 of the point-of-sale terminal 110 of FIG. 1. In the illustrated example, the operator evaluator 300 receives recorded audio from when the operator 116 is speaking to a customer and produces an operator evaluation report 302. The operator evaluator 300 evaluates the word choice and the tone of the operator 116. In the illustrated example, the operator evaluator 300 includes a word choice scorer 304, an operator reference database 306, a tone scorer 308, and an operator scorer 310.

The word choice scorer 304 receives the operator audio. The word choice scorer 304 applies one or more filters to improve the quality of the operator audio, such as ambient noise filtering and audio gain. The word choice scorer 304 generates operator requests 312 based on the filtered operator audio. The operator requests 312 are size-limited portions of the filtered operator audio in a format specified by the transcriber 108. The operator requests 312 may be in an uncompressed format or a lossless compressed format. Because the operator requests 312 are size-limited, the word choice scorer 304 sends multiple operator requests 312 to the transcriber 108. The word choice scorer 304 receives operator responses 314 from the transcriber 108 with transcripts of the operator requests 312.

The operator reference database 306 includes a selection of words and/or phrases and associated scores. Words may be associated with positive or negative scores. For example, the phrase “how may I take your order” may be associated with a positive score, and the phrase “what do you want” may be associated with a negative score. The word choice scorer 304 compares the operator transcripts in the operator responses 314 to the words and/or phrases of the operator reference database 306. The word choice scorer 304 determines a word choice score for the operator 116 based on words and/or phrases in operator transcripts that match the words and/or phrases in the operator reference database 306.

The tone scorer 308 measures the tone and/or the speech rate of the operator 116. The tone scorer 308 uses changes in pitch and amplitude to characterize the attitude (e.g., friendly, cheerful, angry, impatient, etc.) of the operator 116. The tone scorer 308 characterizes the tempo of the operator 116 into different categories (e.g., slow, medium, fast, etc.). Based on the attitude and the speech rate, the tone scorer 308 assigns a tone score to the operator 116.

The operator scorer 310 produces the operator evaluation report 302 based on the word choice score from the word choice scorer 304 and the tone score from the tone scorer 308. In some examples, the operator scorer 310 adds the word choice score to the tone score to evaluate the operator 116. Alternatively, in some examples, the operator scorer 310 scales the word choice score to the tone score. The operator evaluation report 302 may also include words and/or phrases in the operator responses 314 that match words and/or phrases in the operator reference database 306. The operator evaluation report 302 may be used, for example, to create incentives for the operator 116 to create positive interactions with the customers. In some examples, the operator evaluation report 302 is available via the point-of-sale terminal 110 (e.g., an option of the point-of-sale terminal 110 causes the operator evaluation report 302 to appear on the secondary display device 134, etc.).

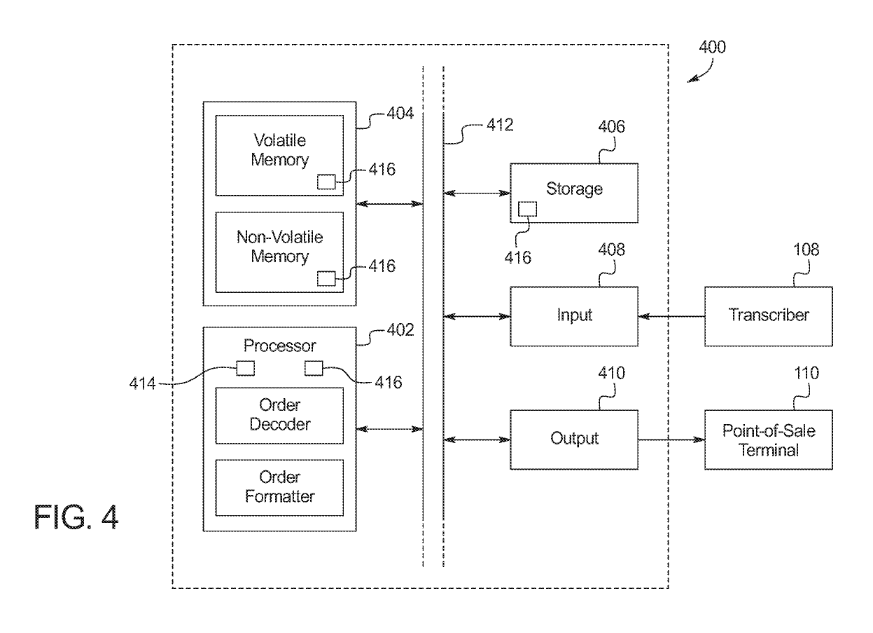

FIG. 4 illustrates a processor platform 400 to implement the order parser 124 of FIGS. 1 and 2 and/or the operator evaluator 300 of FIG. 3. In the illustrated example, the processor platform 400 include a processor or controller 402, memory 404, storage 406, input devices 408, output devices 410, and a data bus 412.

The processor or controller 402 may be any suitable processing device or set of processing devices such as, but not limited to: a microprocessor, a microcontroller-based platform, a suitable integrated circuit, one or more application-specific integrated circuits (ASICs), and/or one or more field programmable gate arrays (FPGAs). In the illustrated example, the processor or controller 402 is structured to include the order decoder 202 and the order formatter 206 of FIG. 2. Additionally or alternatively, in some examples, the processor or controller 402 is structured to include the word choice scorer 304, the tone scorer 308, and the operator scorer 310 of FIG. 3. The processor of the illustrated example 402 includes a cache 414.

The memory 404 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), and read-only memory. In some examples, the memory 404 includes multiple kinds of memory, particularly volatile memory and non-volatile memory. The storage 406 may include any high-capacity storage device, such as a hard drive, and/or a solid state drive. In some examples, the menu reference database 204 of FIG. 2 and/or the operator reference database 306 of FIG. 3 may be stored in the storage 406.

The memory 404, the storage 406, and the cache 414 are a computer readable medium on which one or more sets of instructions 416, such as the software for operating the methods of the present disclosure can be embedded. The instructions 416 may embody one or more of the methods or logic as described herein. In a particular embodiment, the instructions 416 may reside completely, or at least partially, within any one or more of the memory 404, the storage 406, and/or within the processor 402 (e.g., the cache 414, etc.) during execution of the instructions.

The terms “tangible computer-readable medium,” “non-transitory computer-readable medium,” and “computer-readable medium” should be understood to include a single medium or multiple media, such as a centralized or distributed database, and/or associated caches and servers that store one or more sets of instructions. The terms “tangible computer-readable medium,” “non-transitory computer-readable medium,” and “computer-readable medium” also include any tangible medium that is capable of storing, encoding or carrying a set of instructions for execution by a processor, or that cause a system to perform any one or more of the methods or operations disclosed herein. As used herein, the term “computer readable medium” is expressly defined to include any type of computer readable storage device and/or storage disk and to exclude propagating signals.

The input device(s) 408 facilitate a user or another device interacting with the processor platform 400. For example, the input device(s) 408 may be communicatively coupled to the transcriber 108 of FIG. 1. The input device(s) 408 can be implemented by, for example, a serial port, a Universal Serial Bus (USB) port, a IEEE 1339 port, a keyboard, a button, a mouse, a touch screen, a track-pad, and/or a voice recognition system.

The output device(s) 410 facilitate the processor platform 400 providing information to the user and/or another device. For example, the output device(s) 410 may be communicatively coupled to the point-of-sale terminal 110 of FIG. 1. The output devices 410 can be implemented, for example, by display devices (e.g., a light emitting diode (LED), an organic light emitting diode (OLED), a liquid crystal display, a cathode ray tube display (CRT), a touch screen, etc.), and/or communication devices (the serial port, the USB port, the IEEE 1339 port, etc.).

The data bus 412 communicatively couples the processor 402, the memory 404, the storage 406, the input devices 408, and the output devices 410. The data bus 412 may be implemented by one or more interface standards, such as an Ethernet interface, a USB interface, PCI express interface, and/or a Serial ATA interface, etc.

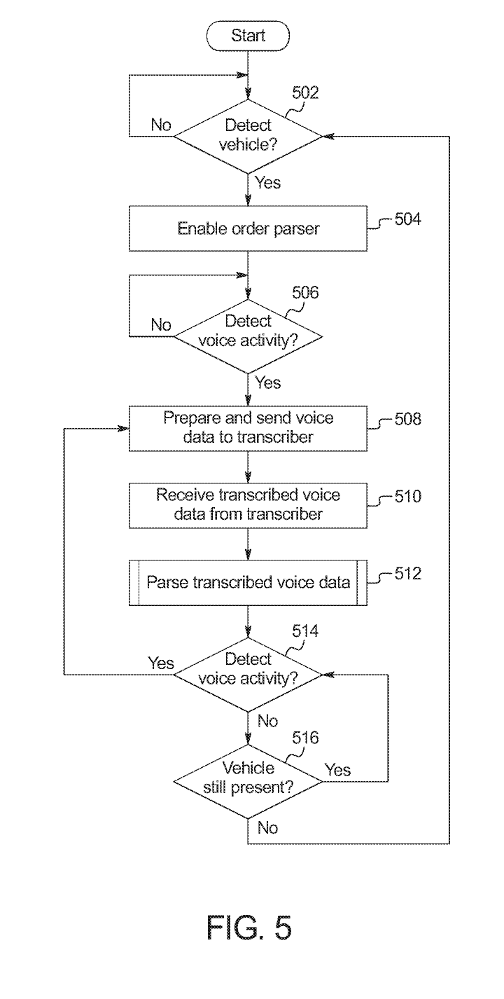

FIG. 5 is a flowchart of an example method to display formatted speech on the point-of-sale terminal 110 that may be implemented by the processor platform 400 of FIG. 4. Initially, the order parser 124 determines whether the vehicle 114 is positioned for a customer to place an order (block 502). To determine whether the vehicle 114 is positioned for a customer to place an order, the order parser 124 waits until the set signal is received from the vehicle detector 120 in response to the vehicle 114 activating the vehicle sensor 104. In response to the set signal, the order parser 124 processes speech responses 128 received from the transcriber 108 (block 504).

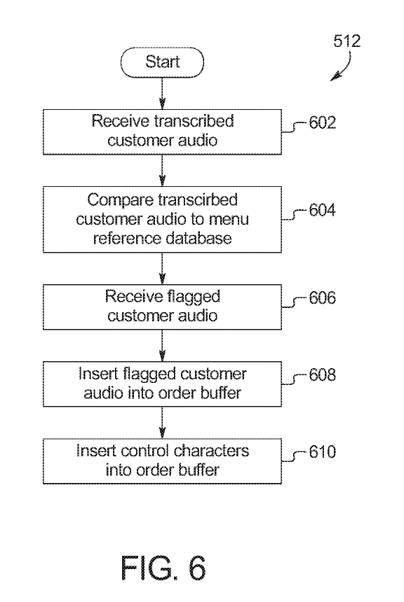

The speech recognition system 122 waits unit the voice detector 118 signals that the voice detector 118 is detecting a voice via the microphone 112 (block 506). The speech recognition system 122 prepares and sends one or more of the speech requests 126 based on the customer audio capture by the microphone 112 (block 508). In some examples, to prepare the speech requests 126, the speech recognition system 122 filters, enhances and/or formats the customer audio. The speech recognition system 122 sends the speech requests 126 via the API provided by the transcriber 108. The order parser 124 receives the speech responses 128 containing the order transcripts from the transcriber 108 (block 510). In some examples, the order parser 124 receives the speech responses 128 via the API provided by the transcriber 108. The order parser 124 parses and formats the order transcripts to prepare the order transcripts to be displayed on the point-of-sale terminal 110 (block 512). An example method of parsing the speech responses 128 is discussed in connection with FIG. 6 below. The speech recognition system 122, via the voice detector 118 determines whether there is more customer audio to process (e.g., the customer is still ordering, etc.) (block 514). If there is more customer audio, the speech recognition system 122 prepares and sends one or more of the speech requests 126 to the transcriber 108 (block 508). Otherwise, if there is no more customer audio, the order parser 124 waits until the vehicle 114 has moved away from the microphone 112 (block 516). It some examples, the order parser 124 determines that the vehicle 114 has moved away from the microphone 112 in response to receiving a reset signal from the vehicle detector 120 indicating that the vehicle 114 is no longer activating the vehicle sensor 104. If the order parser 124 determines that the vehicle 114 has moved away from the microphone 112, the order parser 124 determines whether the next vehicle 114 is positioned for a customer to place an order (block 502).

FIG. 6 is a flowchart of an example method to parse and format transcribed orders that may be implemented by the processor platform 400 of FIG. 4. Initially, the order decoder 202 retrieves the next speech response 128 containing an order transcript (block 602). The order decoder 202 matches words and/or phrases in the order transcript retrieved at block 602 to words and/or phrases in the menu reference database 204 (block 604). For word and/or phrases in the order transcript that correspond to words and/or phrases in the menu reference database 204, the order decoder 202 flags those words and/or phrases in the order transcript. In some examples, the order decoder 202 flags the word and/or phrase based on the type (e.g. menu item phrases, quantity phrases, customization phrases, etc.) associated with the word and/or phrase in the menu reference database 204. Additionally, in some examples, the order decoder 202 removes the words and/or phrases from the order transcript that are not in the menu reference database 204.

The order formatter 206 receives or otherwise retrieves the order transcript from the order decoder 202 (block 606). The order formatter 206 inserts the order transcript into the order buffer 212 (block 608). Based on the flags inserted into the order transcript by the order decoder 202 at block 604, the order formatter 206 inserts control characters into the order transcript (block 610). In some examples, the order formatter 206 inserts (i) a new line control character after menu item phrases, and (ii) a tab control character before the customization phrases and a newline control character after the customization phrases. For example, the order formatter 206 may change the transcribed customer audio “one coffee extra cream two sugars” into “one coffee\n\t extra cream\n\t two sugars\n.” Additionally, the order formatter 206 inserts control characters that cause the secondary display device 134 of the point-of-sale terminal 110 to invert the background color and the text color of the menu item phrases, the quantity phrases, and the customization phrases. The order formatter 206 sends the contents of the order buffer 212 to the secondary display device 134 of the point-of-sale terminal 110.

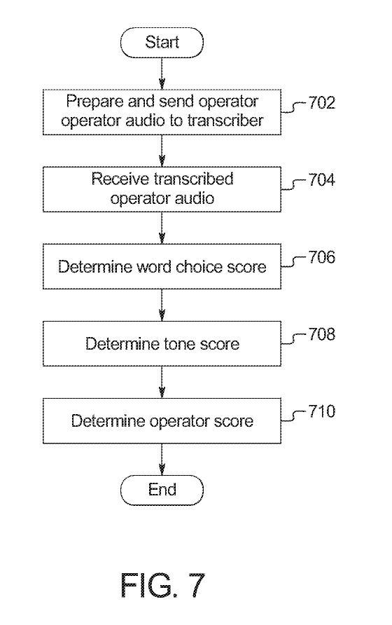

FIG. 7 is a flowchart of an example method to score an operator 116 of the point-of-sale terminal 110 that may be implemented by the processor platform 400 of FIG. 4. Initially, the word choice scorer 304 prepares and sends one or more of the operator requests 312 based on the operator audio capture by a microphone proximate the operator 116 (e.g., on a headset, etc.) (block 702). In some examples, to prepare the operator requests 312, the word choice scorer 304 filters, enhances and/or formats the operator audio. The word choice scorer 304 sends the operator requests 312 via the API provided by the transcriber 108. The word choice scorer 304 receives the operator responses 314 from the transcriber 108 (block 704). In some examples, the word choice scorer 304 receives the operator responses 314 via the API provided by the transcriber 108.

The word choice scorer 304 determines a word choice score based on the transcribed operator audio in the operator responses 314 (block 706). To determine the word choice score, the word choice scorer 304 retrieves scores associated with words and/or phrases in transcribed operator audio that correspond to words and/or phrases from the operator reference database 306. The tone scorer 308 determines a tone score from the operator audio (block 708). The tone score is based on the pitch and tempo of the operator audio. The operator scorer 310 generates an operator evaluation report 302 based on the word choice score and the tone score (block 710). The operator evaluation report 302 provides feedback to the operator regarding interaction with customers. The method of FIG. 7 ends.

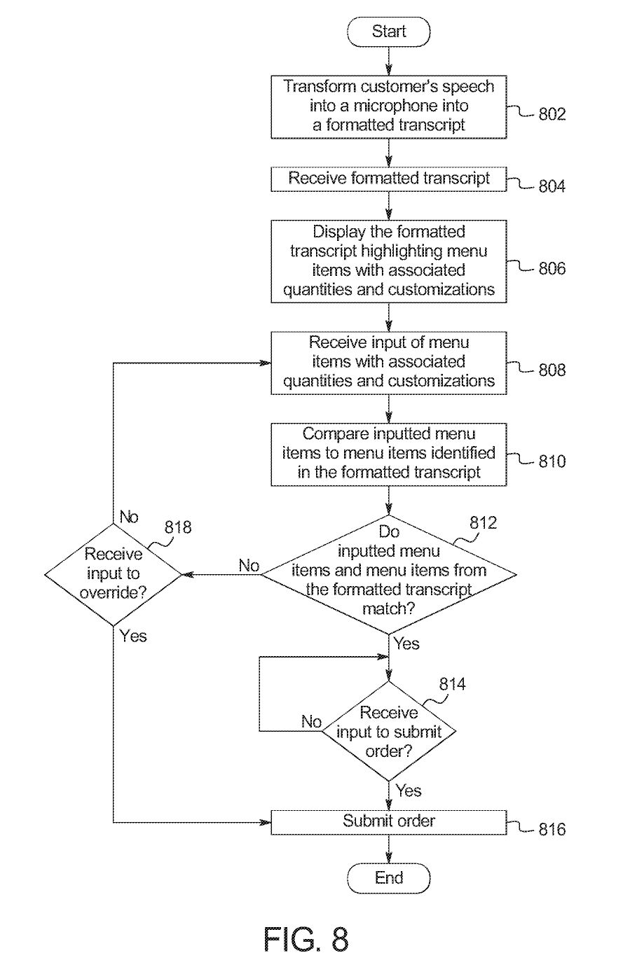

FIG. 8 is a flowchart of an example method to operate a speech-to-order system 106 and/or a point-of-sale terminal 110 in an operator input mode that may be implemented by the processor platform 400 of FIG. 4. This method is initiated when vehicle detector 120 detects a vehicle 114. Initially, the speech-to-order system 106 transforms the customer's speed into the microphone 112 into a formatted transcript (block 802). Example methods to transforms the customer's speed into the formatted transcript are disclosed in FIG. 6 above. The point-of-sale terminal 110 receives or otherwise retrieves the formatted transcript (block 804). The point-of-sale terminal 110 displays the formatted transcript highlighting the menu items with the associated quantities and customizations on the secondary display device 134 (block 806). The point-of-sale terminal 110 receives input of the menu items with the associated quantities and customizations from the operator 116 via the order input device 132 (block 808).

The point-of-sale terminal 110 compares the menu items input at block 808 to the menu items indentified in the formatted transcript at block 806 (block 810). The point-of-sale terminal 110 determines whether the menu items input at block 808 match the menu items indentified in the formatted transcript at block 806 (block 812). When the menu items input by the operator 116 into the order input device 132 match the menu items indentified in the formatted transcript, the method continues at block 814. Otherwise, when the menu items input by the operator 116 into the order input device 132 do not match the menu items indentified in the formatted transcript, the method continues at block 818. The point-of-sale terminal 110 waits until it receives an input to submit the order on the order input device 132 (block 814). When the input to submit the order is received, the point-of-sale terminal 110 submits the order to the item ordering system 111 (block 816).

When the menu items input by the operator 116 into the order input device 132 do not match the menu items indentified in the formatted transcript, the point-of-sale terminal 110 determines whether it has received, via the order input device 132, an input to override a warning provided by the point-of-sale terminal 110 (block 818). When the input to override the warning is not received, the method returns to block 808 to receive input and/or corrections of the menu items with the associated quantities and customizations from the operator 116 via the order input device 132. When the input to override the warning is received, the method continues at block 816 to submit the order to the item ordering system 111.

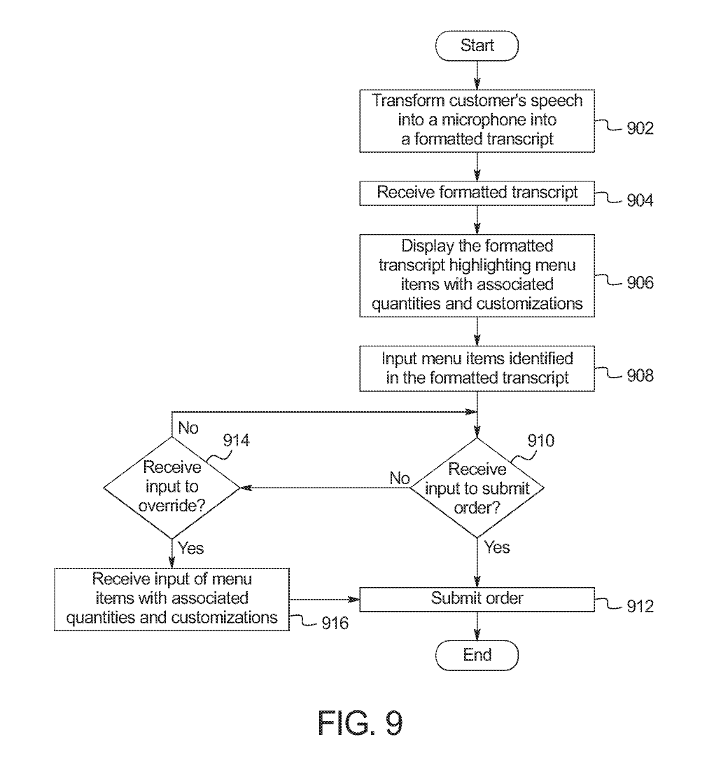

FIG. 9 is a flowchart of an example method to operate the speech-to-order system 106 and/or the point-of-sale terminal 110 in an operator assist mode that may be implemented by the processor platform 400 of FIG. 4. This method is initiated when vehicle detector 120 detects a vehicle 114. Initially, the speech-to-order system 106 transforms the customer's speed into the microphone 112 into a formatted transcript (block 902). Example methods to transforms the customer's speed into the formatted transcript are disclosed in FIG. 6 above. The point-of-sale terminal 110 receives or otherwise retrieves the formatted transcript (block 904). The point-of-sale terminal 110 displays the formatted transcript highlighting the menu items with the associated quantities and customizations on the secondary display device 134 (block 906). The point-of-sale terminal 110 inputs the menu items with the associated quantities and customizations from the formatted transcript (block 908).

The point-of-sale terminal 110 determines whether it receives an input to submit the order by the operator 116 on the order input device 132 (block 910). When the point-of-sale terminal 110 receives the input to submit the order, the method continues at block 912. Otherwise, when the point-of-sale terminal 110 does not receive the input to submit the order, the method continues at block 914. When the input to submit the order is received, the point-of-sale terminal 110 submits the order to the item ordering system 111 (block 912).

When the input to submit the order is not received, the point-of-sale terminal 110 determines whether it has received, via the order input device 132, an input to override the menu items input based on the formatted transcript (block 914). When the input to override the menu items is received, the method continues at block 916. Otherwise, when the input to override the menu items is not received, the method returns to block 910. When the input to override the menu items is received, the point-of-sale terminal 110 receives input of the menu items with the associated quantities and customizations from the operator 116 via the order input device 132 (block 916). The point-of-sale terminal 110 then submits the order to the item ordering system 111 (block 912).

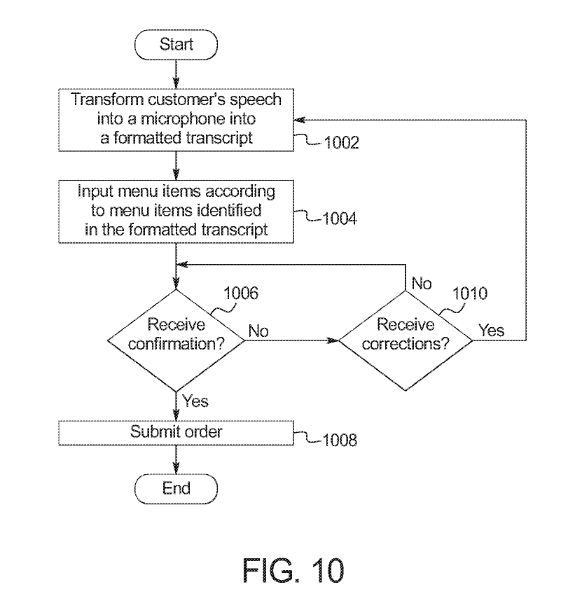

FIG. 10 is a flowchart of an example method to operate the speech-to-order system 106 and/or the point-of-sale terminal 110 in an autonomous mode that may be implemented by the processor platform 400 of FIG. 4. This method is initiated when vehicle detector 120 detects a vehicle 114. Initially, the speech-to-order system 106 transforms the customer's speed into the microphone 112 into a formatted transcript (block 1002). Example methods to transforms the customer's speed into the formatted transcript are disclosed in FIG. 6 above. The point-of-sale terminal 110 inputs the menu items with the associated quantities and customizations from the formatted transcript (block 1004). Alternatively, in some examples, the speech-to-order system 106 inputs the menu items with the associated quantities and customizations from the formatted transcript into the item ordering system 111, but does not flag the order as ready to be processed.

The speech-to-order system 106 determines whether it has received confirmation from the customers on whether the menu items are correct (block 1006). In some examples, the menu items as input into the point-of-sale terminal 110 or the item ordering system 111 are displayed on a display associated with the menu board 102. When confirmation has been received, the method continues at block 1008. Otherwise, when the confirmation has not been received, the method continues at block 1010. When confirmation has been received, the point-of-sale terminal 110 then submits the order to the item ordering system 111 (block 1008). Alternatively, the speech-to-order system 106 flags the order input into the item ordering system 111 as ready to be processed.

When the confirmation has not been received, the speech-to-order system 106 determines whether it has received corrections from the customer via the microphone 112. For example, the customer may say “Change the hamburger to a cheese burger, please.” When the speech-to-order system 106 receives corrections, the method returns to block 1002 to transforms the customer's speed into the microphone 112 into a formatted transcript to identify the corrections and/or menu items. When the speech-to-order system 106 does not receive corrections, the method returns to block 1006.

The flowchart of FIG. 5 is representative of machine readable instructions that comprise one or more programs stored in memory (such as the memory 404 of FIG. 4) that, when executed by a processor (such as the processor 402 of FIG. 4), implement the speech-to-order system 106 of FIG. 1. The flowchart of FIG. 6 is representative of machine readable instructions that comprise one or more programs stored in the memory 404 that, when executed by the processor 402, implement the order parser 124 of FIGS. 1 and 2. The flowchart of FIG. 7 is representative of machine readable instructions that comprise one or more programs stored in the memory 404 that, when executed by the processor 402, implement the operator evaluator 300 of FIG. 3. The flowcharts of FIGS. 8, 9, and 10 are representative of machine readable instructions that comprise one or more programs stored in the memory 404 that, when executed the processor 402 implement the speech-to-order system 106 and/or the point-of-sale terminal of FIGS. 1 and 2. Further, although the example programs are described with reference to the flowchart illustrated in FIGS. 5, 6, 7, 8, 9 and 10, many other methods of implementing the speech-to-order system 106, the order parser 124, the operator evaluator 300 and/or, more generally, the speech-to-order system 106 and/or the point-of-sale terminal 110 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A method comprising:
analyzing, with a processor, a transcript of an order to identify menu items within the transcript;
formatting, with a first format, the transcript to separate and highlight the identified menu items when the transcript is displayed on a screen.

2. The method of claim 1, including before analyzing the transcript of the order, inserting the transcript into a buffer and sending the buffer to the screen.

3. The method of claim 2, including after formatting the transcript, replacing the transcript in the buffer with the formatted transcript and sending the buffer to the screen.

4. The method of claim 1, including comparing the identified menu items to a set of ordered items input by an operator.

5. The method of claim 4, including formatting, with a second format, the identified menu items that are not in the set of ordered items, the second format different that the first format.

6. The method of claim 1, including instructing a point of sale terminal to modify icons representing the identified menu items.

7. The method of claim 1, wherein the transcript of the order is a first transcript, the method including:
analyzing, with the processor, a second transcript of an operator interacting with a consumer that placed the order; and
assigning a score to the operator based on words identified in the second transcript and a tempo of a voice of the operator.

8. An apparatus comprising:
an order decoder configured to:
analyze a transcript of an order to identify menu items within the transcript; and
remove words from the transcript that are not identifies as menu items, and
an order formatter configured to format, with a first format, the transcript to separate and highlight the identified menu items when the transcript is displayed on a screen.

9. The apparatus of claim 8, wherein the order formatter is configured to, before the order decoder analyzes the transcript of the order, insert the transcript into a buffer and send the buffer to the screen.

10. The apparatus of claim 9, the order formatter is configured to, after formatting the transcript, replace the transcript in the buffer with the formatted transcript and send the buffer to the screen.

11. The apparatus of claim 8, wherein the order decoder is configured to compare the identified menu items to a set of ordered items input by an operator.

12. The apparatus of claim 11, wherein the order formatter is configured to format, with a second format, the identified menu items that are not in the set of ordered items, the second format different that the first format.

13. The apparatus of claim 8, wherein the order formatter is configured to instruct a point of sale terminal to modify icons representing the identified menu items.

14. The apparatus of claim 8, wherein the transcript of the order is a first transcript, the apparatus including:
a word scorer configured to analyze a second transcript of an operator interacting with a consumer that placed the order; and
a operator scorer configured to assign a score to the operator based on words identified in the second transcript and a tempo of a voice of the operator.

15. A tangible computer readable medium comprising instructions that, when executed, cause a machine to:
analyze a transcript of an order to identify menu items within the transcript;
remove words from the transcript that are not identifies as menu items, and
format, with a first format, the transcript to separate and highlight the identified menu items when the transcript is displayed on a screen.

16. The computer readable medium of claim 15, wherein the instructions cause the machine to, before analyzing the transcript of the order, insert the transcript into a buffer and send the buffer to the screen.

17. The computer readable medium of claim 16, wherein the instructions cause the machine to, after formatting the transcript, replace the transcript in the buffer with the formatted transcript and send the buffer to the screen.

18. The computer readable medium of claim 15, wherein the instructions cause the machine to compare the identified menu items to a set of ordered items input by an operator.

19. The computer readable medium of claim 18, wherein the instructions cause the machine to format, with a second format, the identified menu items that are not in the set of ordered items, the second format different that the first format.

20. The computer readable medium of claim 15, wherein the transcript of the order is a first transcript, and wherein the instructions cause the machine to:
analyze a second transcript of an operator interacting with a consumer that placed the order; and
assign a score to the operator based on words identified in the second transcript and a tempo of a voice of the operator.
